(19) United States
(12) Patent Application Publication
(10) Pub. No.: US 2026/0171288 A1
(43) Pub. Date: Jun. 18, 2026

(54) HEAT ABSORBING LAYER FOR METAL OXIDE VARISTOR

(71) Applicant: Dongguan Littelfuse Electronics Company Limited, Dongguan City (CN)

(72) Inventors: Oluwaseun K. Oyewole, Fremont, CA (US); Ben Zheng, Bremen (DE); Martin G. Pineda, Fremont, CA (US); Werner Johler, Pfäffikon (CH); Hailang Tang, Dongguan City (CN)

(73) Assignee: Dongguan Littelfuse Electronics Company Limited, Dongguan City (CN)

(21) Appl. No.: 19/414,355

(22) Filed: Dec. 10, 2025

(30) Foreign Application Priority Data
Dec. 18, 2024 (CN) 202411878492.4

(51) Int. Cl. H01C 1/08; H01C 7/108

(52) U.S. Cl. CPC H01C 1/08; H01C 7/108

(57) ABSTRACT

A thermally protected metal oxide varistor (TMOV) device including a MOV chip, a first electrode disposed on a first side of the MOV chip, a second electrode disposed on a second side of the MOV chip opposite the first side, an electrically conductive first lead connected to the first electrode, a heat absorbing layer bound to the second electrode by a heat absorbing paste, the heat absorbing layer formed of a mixture of silica-sand, melamine cyanurate, and silicone, and the heat absorbing paste formed of a mixture of melamine cyanurate silicone, a thermal cutoff (TCO) element extending through a hole in the heat absorbing layer and having a first end electrically connected to the second electrode by a quantity of solder having a melting temperature lower than a melting temperature of the TCO element, and an electrically conductive second lead electrically connected to a second end of the TCO element.

### CROSS-REFERENCE TO RELATED APPLICATIONS

This application claims the benefit of priority to, Chinese Patent Application No. 202411878492.4, filed Dec. 18, 2024, entitled “HEAT ABSORBING LAYER FOR METAL OXIDE VARISTOR,” which application is incorporated herein by reference in its entirety.

### FIELD

The present disclosure relates generally to the field of circuit protection devices. More specifically, the present disclosure relates to a thermally protected metal oxide varistor with enhanced thermal resilience.

### DESCRIPTION OF RELATED ART

Metal oxide varistors (MOVs) are voltage dependent, nonlinear devices that provide transient voltage suppression in electronic circuits. A MOV has high electrical resistance when subjected to a low voltage and a low electrical resistance when subjected to a high voltage. When connected in parallel with a protected circuit component, a MOV can clamp voltage to a safe level in the event of a high transient voltage in the circuit. The MOV thus absorbs energy that could otherwise damage the protected component.

A shortcoming associated with traditional MOVs is that they are prone to electrical punch-through when subjected to high local current, which can lead to excessive heating and subsequent combustion. For example, in the event of an abnormal overvoltage condition, a MOV may overheat and may experience thermal runaway and/or electrical puncture, whereby hot plumes of gas can rupture electrodes on the exterior surfaces of the MOV. To address this issue, there have been developed thermally protected MOV (TMOV) devices. Referring to FIGS. 1A and 1B, there are shown front and rear perspective views of a TMOV device 10 in accordance with the prior art. The TMOV device 10 includes a MOV chip 12 formed of a material having the voltage dependent, nonlinear resistance characteristics described above. The TMOV device 10 further includes first and second electrically conductive electrodes 14a, 14b disposed on opposite sides of the MOV chip 12, as well as electrically conductive first and second leads 15, 16 for facilitating electrical connection of the TMOV device 10 within a circuit. The first lead 15 is connected directly to the first electrode 14a on the first side of the MOV chip 12, and the second lead 16 is connected to a dielectric barrier 17 disposed on the second side of the MOV chip 12. The dielectric barrier 17 prevents direct electrical connection between the second lead 16 and the second electrode 14b. The TMOV device 10 further includes a thermal cutoff (TCO) element 19 having a first end electrically connected to the second lead 16 on the dielectric barrier 17 (e.g., via soldering) and a second end electrically connected to the second electrode 14b. The TCO element 19 is formed of an electrically conductive material and is adapted to melt and separate upon reaching a predetermined temperature (e.g., 140 degrees Celsius - 240 degrees Celsius).

During normal operation, the TMOV device 10 will operate in the manner of a conventional MOV device and will clamp voltage to a safe level in the event of a high transient voltage in a connected circuit. However, upon the occurrence of an overtemperature condition in the TMOV device 10, the TCO element 19 will melt and separate, thereby arresting current flowing through the TMOV device 10 to prevent thermal runaway and electrical puncture. The risk of catastrophic failure (e.g., combustion) is thereby mitigated.

In some cases, the TCO element of a TMOV device may open prematurely (i.e., in the absence of a true fault condition), such as if the TMOV device is operated for an extended period of time and/or in a hot environment. It is therefore desirable to provide a TMOV device having enhanced thermal resilience wherein the TCO element of the TMOV device is not prone to premature opening. It is with respect to these and other considerations that the present improvements may be useful.

### SUMMARY

This Summary is provided to introduce a selection of concepts in a simplified form further described below in the Detailed Description. This Summary is not intended to identify key features or essential features of the claimed subject matter, nor is the summary intended as an aid in determining the scope of the claimed subject matter.

A thermally protected metal oxide varistor (TMOV) device according to an embodiment of the present disclosure may include a MOV chip, a first electrode disposed on a first side of the MOV chip, a second electrode disposed on a second side of the MOV chip opposite the first side, an electrically conductive first lead connected to the first electrode, a heat absorbing layer bound to the second electrode by a heat absorbing paste, the heat absorbing layer formed of a mixture of silica-sand, melamine cyanurate, and silicone, and the heat absorbing paste formed of a mixture of melamine cyanurate silicone, a thermal cutoff (TCO) element extending through a hole in the heat absorbing layer and having a first end electrically connected to the second electrode by a quantity of solder having a melting temperature lower than a melting temperature of the TCO element, and an electrically conductive second lead electrically connected to a second end of the TCO element.

A thermally protected metal oxide varistor (TMOV) device according to another embodiment of the present disclosure may include a MOV chip, an electrically conductive first electrode disposed on a first side of the MOV chip, an electrically conductive second electrode disposed on a second side of the MOV chip opposite the first side, an electrically conductive first lead connected to the first electrode, a heat absorbing layer bound to the second electrode by a heat absorbing paste, the heat absorbing layer formed of a mixture of silica-sand, melamine cyanurate, and silicone, and the heat absorbing paste formed of a mixture of melamine cyanurate silicone, a thermal cutoff (TCO) element extending through a hole in the heat absorbing layer and having a first end electrically connected to the second electrode by a quantity of solder having a melting temperature lower than a melting temperature of the TCO element, and an electrically conductive second lead electrically connected to a second end of the TCO element.

### BRIEF DESCRIPTION OF THE DRAWINGS

FIGS. 1A and 1B are a front perspective view and a rear perspective view illustrating a thermally protected metal oxide varistor device in accordance with the prior art;

FIGS. 2A-2C are a front perspective view, a rear perspective view, and an exploded view illustrating a thermally protected metal oxide varistor device in accordance with an embodiment of the present disclosure; and

FIGS. 3A-3E are a series of perspective views illustrating a process of assembling the thermally protected metal oxide varistor device shown in FIGS. 2A-2C.

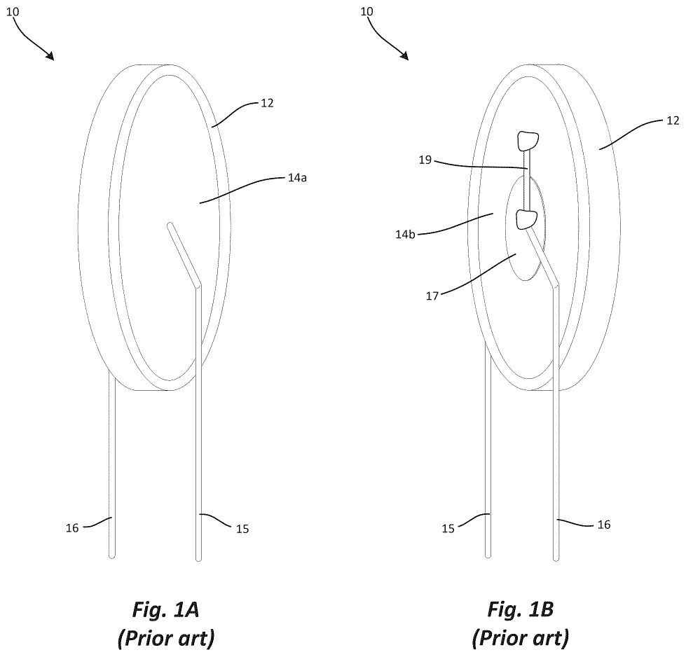

### DETAILED DESCRIPTION

Exemplary embodiments of a thermally protected metal oxide varistor (TMOV) device in accordance with the present disclosure will now be described more fully hereinafter with reference to the accompanying drawings. The TMOV device may, however, be embodied in many different forms and should not be construed as being limited to the embodiments set forth herein. Rather, these embodiments are provided so that this disclosure will convey certain exemplary aspects of the TMOV devices to those skilled in the art.

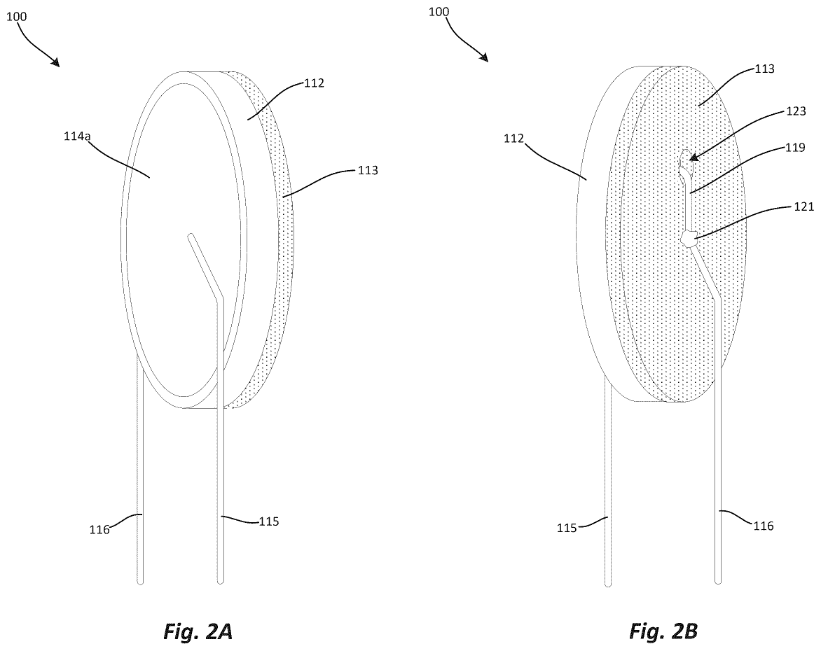

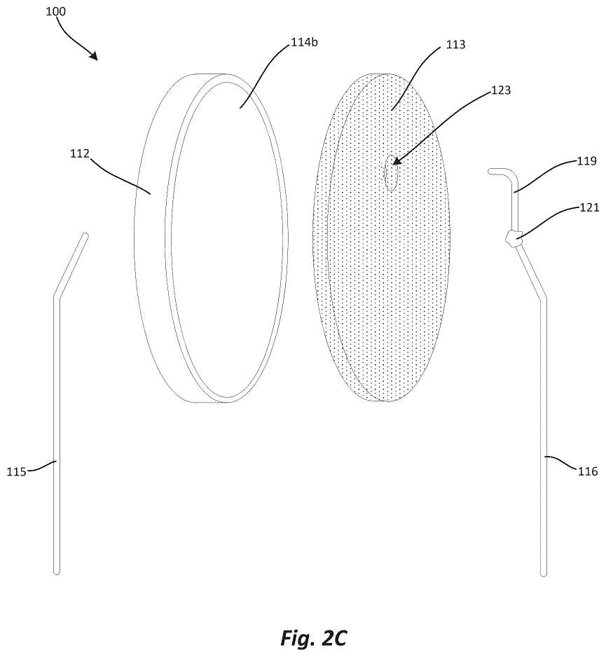

Referring to FIGS. 2A-2C, front, rear, and exploded views of an exemplary embodiment of a thermally protected metal oxide varistor device 100 (hereinafter “the TMOV device 100”) in accordance with the present disclosure are shown. The TMOV device 100 may include a MOV chip 112 having electrically conductive first and second electrodes 114a, 114b disposed on opposing first and second sides thereof. The MOV chip 112 may be formed of any MOV composition known in the art, such as zinc oxide granules embedded in ceramic. The present disclosure is not limited in this regard. The first and second electrodes 114a, 114b of the TMOV device 100 may be formed of a metal having good electrical conductivity, including, but not limited to, aluminum, copper, silver, tin, etc. The present disclosure is not limited in this regard.

The TMOV device 100 may further include a heat absorbing layer 113 disposed on the second side of the MOV chip 112 in flat abutment with the second electrode 114b. The heat absorbing layer 113 may be formed of a mixture of silica-sand, melamine cyanurate, and silicone that may be poured into a mold, pressed, and cured (e.g., hot pressed at a temperature ranging from room temperature to 170 degrees Celsius), and subsequently punched or cut into a desired shape (e.g., a round disc as shown). In various embodiments, the aforementioned mixture may contain silica-sand, melamine cyanurate, and silicone in a ratio of 8:1:1. The present disclosure is not limited in this regard. The heat absorbing layer 113 may be affixed to the second electrode 114b by a heat absorbing paste as further described below.

The MOV chip 112, the first and second electrodes 114a, 114b, and the heat absorbing layer 113 are depicted as being circular in shape, but this is not critical. It is contemplated that one or more of the MOV chip 112, the first and second electrodes 114a, 114b, and the heat absorbing layer 113 may have a different shape, such as rectangular, triangular, irregular, etc. without departing from the scope of the present disclosure. The heat absorbing layer 113 is shown as covering an entirety of the second electrode 114b and an entirety of the second side of the MOV chip 112. The present disclosure is not limited in this regard. In various, non-limiting embodiments, the heat absorbing layer 113 may cover at least 80% of the second side of the MOV chip.

The TMOV device 100 may further include electrically conductive first and second leads 115, 116 for facilitating electrical connection of the TMOV device 100 within a circuit. The first lead 115 may be connected directly to the first electrode 114a on the first side of the MOV chip 112 via soldering, welding, electrically conductive adhesive, etc. The second lead 116 may be connected to a first end of a thermal cutoff (TCO) element 119, such as with solder 121. The TCO element 119 may extend through an aperture 123 formed in the heat absorbing layer 111 (e.g., via drilling) and may be attached at a second end to the second electrode 114b, such as with solder as further described below. The TCO element 119 may be formed of an electrically conductive material that may be adapted to melt and separate upon reaching a predetermined temperature (e.g., 140 degrees Celsius-240 degrees Celsius). In various embodiments, the TCO element 119 may be formed of solder having a melting temperature that is higher than a melting temperature of the solder used to connect the TCO element 119 to the second lead 116 and to second electrode 114b.

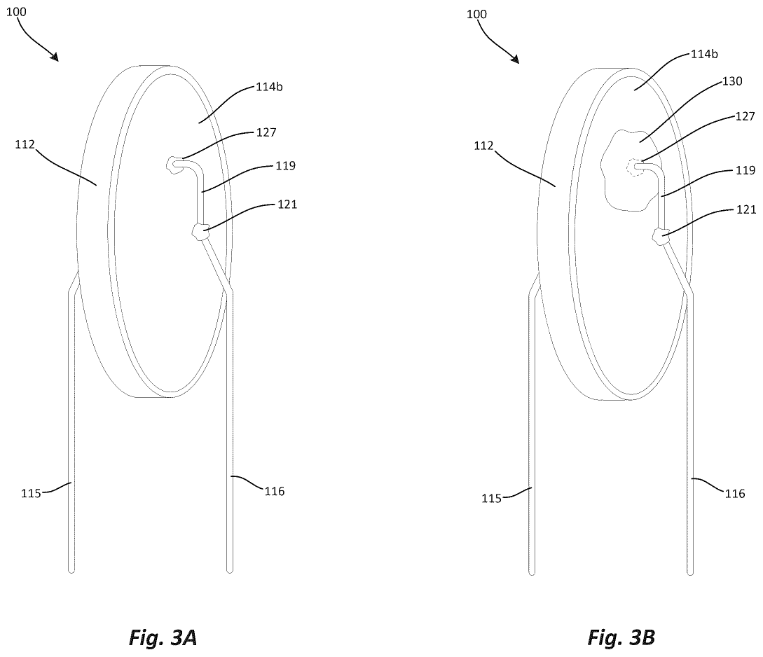

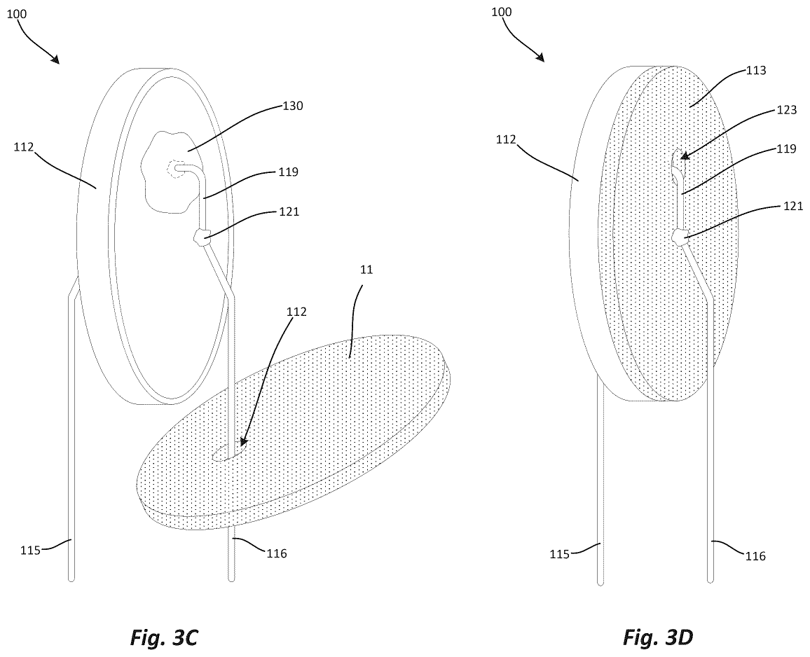

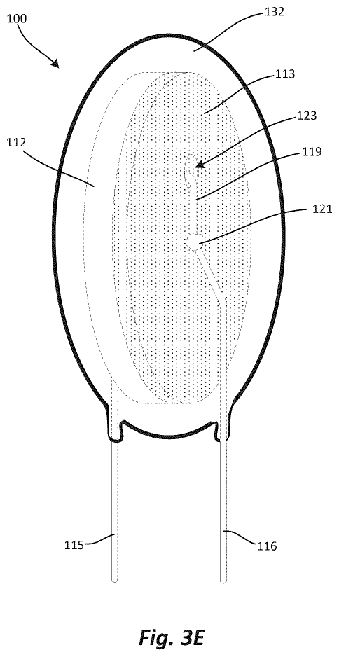

Referring to FIGS. 3A-3E, a series of view illustrating a process of assembling the TMOV device 100 is shown. In FIG. 3A, the first lead 115 may be electrically connected to the first electrode 114a, and the TCO element 119 may be electrically connected to the second electrode 114b. In various embodiments, the TCO element 119 may be electrically connected to the second electrode 114b with a quantity of solder 127 having a melting temperature that is lower than the melting temperature of the solder forming TCO element 119 as described above. Thus, the solder 123 can be heated and reflowed to join the TCO element 119 to the second electrode 114b without melting the TCO element 119.

In FIG. 3B, a heat absorbing paste 130 may be applied to the second electrode 114b and may substantially cover the solder 127 at the juncture of the TCO 119 element and the second electrode 114b. The heat absorbing paste 130 may be formed of a mixture of melamine cyanurate and silicone. In various embodiments, the aforementioned mixture may contain melamine cyanurate and silicone in a ratio of 1:1. The present disclosure is not limited in this regard.

In FIG. 3C, the second lead 116 may be threaded through the aperture 123 of the heat absorbing layer 113, and the heat absorbing layer 113 may be moved or slid over the second lead 116 and the TCO element 119 and may be rotated and/or tilted into flat engagement with the second electrode 114b to cover the second side of the MOV chip 112 as shown in FIG. 3D. The heat absorbing paste 130 may then be cured (e.g., at 170 degrees Celsius for 2-4 minutes) and may thereafter bond the heat absorbing layer 113 to the second electrode 114b.

In FIG. 3E, a protective, dielectric coating 132 applied over the MOV chip, 112, the first and second electrodes 114a, 114b, the heat absorbing layer 113, the TCO element 119, and portions of the first and second leads 115, 116. In various embodiments, the dielectric coating 132 may be formed of epoxy and may be applied via dipping, jetting, or the like. In various embodiments, the dielectric coating 132 may be entirely omitted. The present disclosure is not limited in this regard.

During normal operation of the TMOV device 100, the heat absorbing layer 113 and the heat absorbing paste 130 may absorb heat to prevent the TCO element 119 from being melted/opened prematurely, which could otherwise occur due to an accumulation of heat in the TMOV device 100 resulting from an extended period of operation and/or from operation in a hot environment. The heat absorbing layer 113 and the heat absorbing paste 130 may similarly prevent premature melting/opening of the solder 127 connecting the TCO element 119 to the second electrode and/or the solder 123 connecting the TCO element 119 to the second lead 116.

Upon the occurrence of a true fault condition in the TMOV device 100 (e.g., an extreme overvoltage condition), the heat absorption capabilities of the heat absorbing layer 113 and the heat absorbing paste 130 may be exceeded and TCO element 119 may melt, thereby arresting current flowing through the TMOV device 100 and preventing further heating that could ignite the TMOV device 100 and damage surrounding components. When the TCO element 119 opens, an electrical arc may propagate across the gap left between the separated TCO element 119 and the second electrode 114a. Heat from the electrical arc may burn and decompose the silicone in the heat absorbing layer 113 and/or the heat absorbing paste 130. As the silicone decomposes, the melamine cyanurate in the heat absorbing layer 113 and/or in the heat absorbing paste 130 may be exposed and may also be burned by the heat from the electrical arc. As the melamine cyanurate is burned and decomposes, it may undergo an endothermic chemical reaction that absorbs heat. The electrical arc is thereby rapidly cooled. Furthermore, certain byproducts of the endothermic chemical reaction may be nonconductive gases (e.g., ammonia) that may hinder the ability of the electrical arc to persist. Still further, other byproducts of the endothermic chemical reaction may produce water, which may further cool the electrical arc. Thus, the heat absorbing layer 113 and/or the heat absorbing paste 130 may, upon the occurrence of a fault condition in the TMOV device 100, absorb heat, release gases that are unfavorable to sustaining an electrical arc, and produce water which may further cool the electrical arc, all of which may contribute to rapid arc quenching. Components that are connected to the TMOV device 100 and/or that are located in the proximity of the TMOV device 100 are thereby protected from damage that might otherwise result if the electrical arc were allowed to persist.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A thermally protected metal oxide varistor (TMOV) device comprising:
a MOV chip;
an electrically conductive first electrode disposed on a first side of the MOV chip;
an electrically conductive second electrode disposed on a second side of the MOV chip opposite the first side;
an electrically conductive first lead connected to the first electrode;
a heat absorbing layer disposed on the second electrode;
a thermal cutoff (TCO) element extending through the heat absorbing layer and having a first end electrically connected to the second electrode; and
an electrically conductive second lead electrically connected to a second end of the TCO element.

2. The TMOV device of claim 1, wherein the TCO element is formed of an electrically conductive material and is adapted to melt and separate upon reaching a predetermined temperature.

3. The TMOV device of claim 1, wherein the TCO element is formed of solder.

4. The TMOV device of claim 1, wherein the heat absorbing layer is formed of a mixture including melamine cyanurate.

5. The TMOV device of claim 4, wherein the heat absorbing layer is formed of a mixture including silica-sand, melamine cyanurate, and silicone.

6. The TMOV device of claim 5, wherein the heat absorbing layer is formed of a mixture of silica-sand, melamine cyanurate, and silicone in a ratio of 8:1:1.

7. The TMOV device of claim 1, wherein the heat absorbing layer covers at least 80% of the second side of the MOV chip.

8. The TMOV device of claim 1, wherein the heat absorbing layer is bound to the second electrode by a heat absorbing paste.

9. The TMOV device of claim 8, wherein the heat absorbing paste is formed of a mixture of melamine cyanurate and silicone.

10. The TMOV device of claim 9, wherein the heat absorbing paste is formed of a mixture of melamine cyanurate and silicone in a ratio of 1:1.

11. The TMOV device of claim 8, wherein the heat absorbing paste covers a juncture of the TCO element and the second electrode.

12. The TMOV device of claim 1, wherein the TCO element is connected to the second electrode by a quantity of solder having a melting temperature that is lower than a melting temperature of the TCO element.

13. The TMOV device of claim 1, wherein the MOV chip, the first and second electrodes, the heat absorbing layer, the TCO element, and portions of the first and second leads are covered by a dielectric coating.

14. The TMOV device of claim 13, wherein the dielectric coating is formed of epoxy.

15. A thermally protected metal oxide varistor (TMOV) device comprising:
a MOV chip;
an electrically conductive first electrode disposed on a first side of the MOV chip;
an electrically conductive second electrode disposed on a second side of the MOV chip opposite the first side;
an electrically conductive first lead connected to the first electrode;
a heat absorbing layer bound to the second electrode by a heat absorbing paste, the heat absorbing layer formed of a mixture of silica-sand, melamine cyanurate, and silicone, and the heat absorbing paste formed of a mixture of melamine cyanurate silicone;
a thermal cutoff (TCO) element extending through a hole in the heat absorbing layer and having a first end electrically connected to the second electrode by a quantity of solder having a melting temperature lower than a melting temperature of the TCO element; and
an electrically conductive second lead electrically connected to a second end of the TCO element.

16. The TMOV device of claim 15, wherein the heat absorbing layer is formed of a mixture of silica-sand, melamine cyanurate, and silicone in a ratio of 8:1:1.

17. The TMOV device of claim 15, wherein the heat absorbing layer covers at least 80% of the second side of the MOV chip.

18. The TMOV device of claim 15, wherein the heat absorbing paste is formed of a mixture of melamine cyanurate and silicone in a ratio of 1:1.

19. The TMOV device of claim 15, wherein the heat absorbing paste covers a juncture of the TCO element and the second electrode.
